(19) United States
(12) Patent Application Publication
(10) Pub. No.: US 2019/0066132 A1
(43) Pub. Date: Feb. 28, 2019

(54) SYSTEM AND METHOD FOR ASSESSING DIGITAL CONTENT PRESENTATIONS

(71) Applicant: Cognant LLC, Mountain View, CA (US)

(72) Inventors: Kent Shi, Sunnyvale, CA (US); Jerome Turnbull, Mountain View, CA (US); Arun Kejariwal, Fremont, CA (US); Martin Ochwat, Palo Alto, CA (US)

(21) Appl. No.: 16/106,539

(22) Filed: Aug. 21, 2018

Related U.S. Application Data
(60) Provisional application No. 62/549,537, filed on Aug. 24, 2017.

(51) Int. Cl. G06Q 30/02; G06F 17/50; G06F 17/18

(52) U.S. Cl. CPC G06Q 30/0202; G06F 17/18; G06F 17/5009

(57) ABSTRACT

A computer-implemented method and a system are provided for estimating values for user events associated with digital content presentations. An example method includes: providing data having a plurality of targeting features for a plurality of users of a software application; performing regression analyses to generate a first predictive model and a second predictive model, wherein the first predictive model is configured to receive targeting features as input and provide as output a prediction of an amount of revenue generated per payer, and wherein the second predictive model is configured to receive at least one targeting feature as input and provide as output a prediction of a number of payers per user event; using the first and second models to determine a value of a user event for a set of targeting parameters; and facilitating a presentation of content on a plurality of client devices based on the determined value.

### CROSS-REFERENCE TO RELATED APPLICATIONS

This application claims the benefit of U.S. Provisional Patent Application No. 62/549,537, filed Aug. 24, 2017, the entire contents of which are incorporated by reference herein.

### BACKGROUND OF THE INVENTION

The present disclosure relates generally to the presentation of digital content by publishers and, in certain examples, to systems and methods for developing and using regression models for determining a value of digital content presentations and, more particularly, for determining a value of user events or activity taken in response to the digital content presentations.

In general, client devices are capable of presenting a wide variety of content, including images, video, audio, and combinations thereof. Such content can be stored locally on client devices and/or can be sent to the client devices from server computers over a network (e.g., the Internet). To watch an online movie, for example, a user of a client device can download a copy of the movie and/or can stream the movie from a content provider. Online content can be provided to client devices by publishers, such as websites and software applications.

Users can interact with content in various ways. A user can, for example, view images, listen to music, or play computer games. With certain online content, a user can select the content or a portion thereof and be directed to a website where further content can be presented or obtained. In some instances, users can download or receive content in the form of software applications.

Companies can spend millions of dollars daily publishing content via various media and via multiple channels. Some channels available to companies can access users at a very granular level by providing multiple targeting or user parameters. For example, for the purpose of illustration and not limitation, some common targeting parameters can include user segments, such as, for example, age, gender, location, language, platform, device, interests, and the like. The cardinality of certain targeting parameters can be on the order of thousands (e.g., device) or even millions (e.g., interests).

If, for example, one assumes that, for a discrete system, there are N targeting parameters (x₁, x₂, . . . x_{N}) and a unique instance of this vector is denoted as a user segment, the number of possible user segments can be defined by the relationship:

Πᵢ₌₁^{N}|xᵢ| (1)

in which |xᵢ| is the cardinality of the i^{th} targeting parameter. If all available targeting parameters are used, the result can be astronomical, e.g., greater than 10¹⁰⁰. Accordingly, it is not reasonable, feasible, and/or advisable to publish content for every possible user segment.

### SUMMARY OF THE INVENTION

In general, the subject matter of this disclosure relates to determining values for user events or actions taken on client devices, for example, in response to or in association with digital content presentations. Such user events can include, for example, installing a software application, interacting with the software application, and/or making advancements in the software application. Data are provided that include a plurality of targeting features (e.g., user or client device characteristics) for a plurality of users of the software application. Two regression analyses are performed to develop a first predictive model and a second predictive model. The first predictive model is configured to receive one or more targeting features as input and provide as output a prediction of an amount of revenue generated per payer (e.g., a user who generates revenue) for the software application. The second predictive model is configured to receive one or more targeting features as input and provide as output a prediction of a number of payers per user event for the software application. The first and second predictive models are then used to determine a value of a user event (e.g., a software installation) for a set of targeting features. In some instances, the determined value can be used to generate a bid for a content presentation. When the bid is accepted, a publisher can proceed to present the content on one or more client devices.

Advantageously, the predictive models described herein are able to determine values for user events and, if desired, compute bids for one or more user segments or combinations thereof, based on the determined values. The user segments can include active user segments that cover current users of the software application. Additionally or alternatively, the user segments can cover prospective or future users of the software application. In preferred implementations, bids can be computed that achieve a desirable return on investment and/or result in content presentations that achieve a maximum exposure to prospective users.

Advantageously, the systems and methods described herein can use two regression models (e.g., the first and second predictive models) to determine values for user events in an indirect or two-step approach, and this indirect approach is generally more accurate than alternative or direct approaches in which a single regression model is used. For example, the direct approach can be more susceptible to erroneous predictions caused by anomalous user activity. Such anomalous user activity can be due to, for example, a small portion of users who are much more active in a software application than other users, or who generate much more revenue for the software application than other users. Such high-spending users can be referred to herein as “whales.” When such anomalous user activity is reflected in data used to generate the predictive models, the indirect approach described herein (involving two predictive models) is generally more accurate than the direct approach (involving a single predictive model). For example, compared to the direct approach, the indirect approach can achieve the following advantages: accurate user event values (e.g., non-zero values) can be predicted for any or all user segments, including user segments that have not generated any revenue or do not cover any current users of the software application; unreasonably high predicted user event values, such as those attributable to whales, can be avoided or minimized; user event values can be predicted for new user segments for which no prior data exist; and user event values can be predicted for whale-like user segments that have not received revenue from a whale.

In a first aspect, the subject matter described in this specification relates to a computer-implemented method for determining a value of a user event (e.g., an installation of the software application and/or a user accomplishment in the software application). In some embodiments, the method includes the steps of: providing data including a plurality of targeting features (e.g., a user segment and/or an external feature) for a plurality of users of a software application (e.g., a history of user interactions with the software application); identifying a plurality of payers within the plurality of users; performing a first regression analysis on the data to generate a first predictive model, the first predictive model being configured to receive one or more targeting features as input and provide as output a prediction of an amount of revenue generated per payer for the software application; performing a second regression analysis on the data to generate a second predictive model, the second predictive model being configured to receive one or more targeting features as input and provide as output a prediction of a number of payers per user event (e.g., a payer-to-install ratio) for the software application; providing a set of targeting parameters to the first predictive model and the second predictive model; receiving outputs from the first predictive model and the second predictive model; determining a value of the user event based on a combination of the outputs; and facilitating a presentation of content on a plurality of client devices based on the determined value.

In some implementations, performing the first regression analysis can include calculating, based on the data, an amount of revenue generated by each payer for the software application and/or performing the second regression analysis can include calculating, based on the data, a number of payers per user event. Moreover, in some variations, the first predictive model and/or the second predictive model can include a Random Forest model.

In some applications, providing the set of targeting parameters can include determining the set of targeting parameters for a group of prospective users of the software application and/or determining the value of the user event can include multiplying output from the first predictive model by output from the second predictive model.

In a second aspect, the subject matter described in this specification relates to a system for determining a value of a user event. In some embodiments, the system includes one or more computer processors programmed to perform operations that can include providing data including a plurality of targeting features (e.g., a user segment and/or an external feature) for a plurality of users of a software application; identifying a plurality of payers within the plurality of users; performing a first regression analysis on the data to generate a first predictive model, the first predictive model being configured to receive one or more targeting features as input and provide as output a prediction of an amount of revenue generated per payer for the software application; performing a second regression analysis on the data to generate a second predictive model, the second predictive model being configured to receive one or more targeting features as input and provide as output a prediction of a number of payers per user event (e.g., a payer-to-install ratio) for the software application; providing a set of targeting parameters to the first predictive model and the second predictive model; receiving outputs from the first predictive model and the second predictive model; determining a value of the user event based on a combination of the outputs; and facilitating a presentation of content on a plurality of client devices based on the determined value.

In some implementations, performing the first regression analysis can include calculating, based on the data, an amount of revenue generated by each payer for the software application and/or performing the second regression analysis can include calculating, based on the data, a number of payers per user event. Moreover, in some variations, the first predictive model and/or the second predictive model can include a Random Forest model.

In some applications, providing the set of targeting parameters can include determining the set of targeting parameters for a group of prospective users of the software application and/or determining the value of the user event can include multiplying output from the first predictive model by output from the second predictive model.

In a third aspect, the subject matter described in this specification relates to an article. The article includes a non-transitory computer-readable medium having instructions stored thereon that, when executed by one or more computer processors, cause the computer processors to perform operations including: providing data including a plurality of targeting features for a plurality of users of a software application; identifying a plurality of payers within the plurality of users; performing a first regression analysis on the data to generate a first predictive model, the first predictive model being configured to receive one or more targeting features as input and provide as output a prediction of an amount of revenue generated per payer for the software application; performing a second regression analysis on the data to generate a second predictive model, the second predictive model being configured to receive one or more targeting features as input and provide as output a prediction of a number of payers per user event for the software application; providing a set of targeting parameters to the first predictive model and the second predictive model; receiving outputs from the first predictive model and the second predictive model; determining a value of the user event based on a combination of the outputs; and facilitating a presentation of content on a plurality of client devices based on the determined value.

Elements of embodiments described with respect to a given aspect of the invention can be used in various embodiments of another aspect of the invention. For example, it is contemplated that features of dependent claims depending from one independent claim can be used in apparatus, systems, and/or methods of any of the other independent claims.

### DESCRIPTION OF THE DRAWINGS

FIG. 1 is a flowchart of an exemplary method of estimating a value for publishing content in accordance with some embodiments of the present invention.

FIG. 2 is a schematic diagram of a system for executing the method shown in FIG. 1, in accordance with certain examples of this disclosure.

FIG. 3 is a flowchart of an exemplary method of determining a value of user events associated with digital content presentations.

### DETAILED DESCRIPTION

In general, there can be several pricing models for determining costs associated with publishing content, such as cost-per-click (CPC), cost-per-install (CPI), cost-per-event (CPE), and so forth. A CPC pricing model can award the content publisher or the network publishing the content whenever a user, who is on the publisher's website, clicks on the content appearing on some portion of the screen. Typically, businesses pay a premium for published content that appears or is displayed on what are deemed more strategic portions of the viewing screen. A CPI pricing model awards the content publisher or network publishing the content whenever a user installs, on the user's processing device, an algorithm, application, driver program, software, or the like made available for installation.

CPI pricing models can be used primarily in connection with the installation of mobile applications (“apps”), by which the content publisher or network publishing the content can receive compensation for the installation. The compensation paid by the content provider to the content publisher or to the network publishing the content can be based on a bid price for publishing the content. Disadvantageously, there are no fast and sure rules for determining what constitutes an appropriate bid for content publishing. In some instances, an appropriate bid can be determined by computing an average return per installation (ARPI). For example, if the publication of content resulted in ten (10) installations and the revenue produced by those ten (10) installation is $100, then the ARPI would be $10 (=$100/10). In short, if the content provider bids a $10 CPI, then the content provider would break even, since the income generated by the total number of installations is equal to the amount paid to the content publisher or network publishing the content for each installation. Thus, content providers who offer a $10 CPI bid receive greater value for their investment when the published content generates more than $10 of revenue per installation, but receive less value for their investment if the published content generates less than $10 of revenue per installation.

An additional aspect of estimating and settling on CPI bids for publishing content can involve the content provider establishing a desired or expected return on investment (ROI) and factoring the ROI into the analysis. For example, if the content provider's goal is to achieve a 20% ROI, then, for an ARPI of $10, the maximum amount the content bidder should bid for publishing its content is $8.33, corresponding to the quotient of the ARPI divided by one (1) plus the ROI (i.e., $10/(1+0.2)).

In many instances, when formulating a bid, neither the number of installations that will result from the published content nor the revenue that will be generated by the installations is known in advance. Hence, a break-even ARPI may not be known beforehand, further complicating bidding. Hence, a method of predicting both the likely number of installations and the likely revenue generated from the installations is desirable. Moreover, although a large number of content items can be published at a time, only a small proportion of the content may receive a meaningful number (e.g., 10⁵ or greater) of impressions. Fewer still is the number of installed content that also generate or deliver revenue to the content provider. As a result, even if the revenue for the installed content were known beforehand, for a meaningful number of impressions in excess of 10⁵ used as a basis for preparing bids for publishing content, by its very nature, the ARPI may remain close to zero for most content. Accordingly, there can be problems with using ARPI to establish bids for publishing content.

Another facet affecting bid price estimations for publishing content can involve accounting for “whales.” In certain examples, whales are individuals, or payers, who spend a relatively large and statistically significant amount of money on online mobile products (e.g., mobile games, such as, for example, a massively multiplayer online (MMO) game, and the like). Because of their small number but high spending habits, whales tend to skew the bid results. Indeed, although only a single payer, a whale can contribute several orders of magnitude more revenue than other payers who installed the online mobile product. The effect of whales on distribution of revenue by payer can result in a power law function, as a large portion of the revenue generated by the published content can be received from a very small number of payers, while, conversely, a very small portion of the revenue can be generated by a large majority of those who installed the mobile product.

Conventionally, under the best of circumstances, only a few payers generate revenue attributable to the downloading of a mobile app. If, however, one of those payers is a whale, then adherence to a conventional ARPI approach to bid formulation can result in an exorbitantly high bid, which is undesirable, as being uneconomical or not cost effective. Equally as undesirable, however, would be discounting a whale(s) and removing the whale outlier(s) from the analysis altogether. Such an approach can overlook a large portion of the revenue generated, resulting in unrepresentative, very low bids. Offering a low bid can result in publication of the content in a less favorable portion of the webpage screen, where it may not be seen by potential payers.

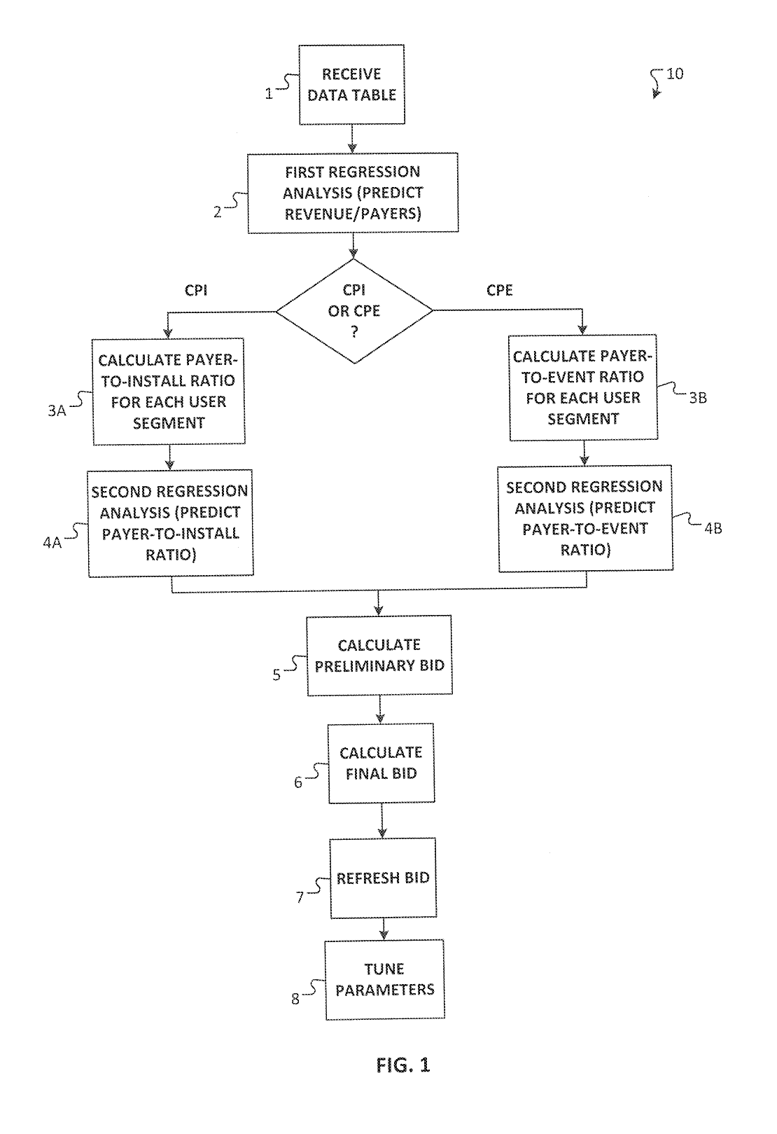

An exemplary embodiment of a computer-implemented method 10 of estimating a value for publishing digital content is shown in FIG. 1. In a first step, using, for example, an SQL or similar database, data can be arrayed in a data table (STEP 1). In some implementations, the data table can be structured and arranged to contain a listing of (1) all the content (e.g., videos, images, offers, etc.) launched, as well as the targeting specifications for each; (2) all users, including the content that each user is attributed to (e.g., which apps the user has installed historically); and (3) revenue generated by each user. Other types of data in the data table are possible. Each row in the data table can represent an acquired user. Columns in the data table can represent, for example, any number (n) of features, as well as the revenue generated by the user and an indicia (e.g., a binary 1 or 0) of whether the user generated some revenue (1) or not (0). In various examples, a user who generates revenue or makes purchases in or for a software application can be referred to as a “payer.” Columnar features can include user segments, external features, temporal features, and so forth. User segments can be or include, for example, one or more of: age, gender, location, language, platform, device, interests, and the like. External features are generally features that are not specific to a user and/or that relate to the user's equipment, location, and/or setting. External features for a user can be or include, for example, one or more of: hour of day, day of the week, weekend or holidays, client device cost, client device resolution, client device age, primary religion in the user's location, form of government in the user's location, gross domestic product (GDP) per capita, Gini index in the user's location, human development index in the user's location, and so forth.

Day of the week can be included among the features to account for temporal trends in revenue generation. For example, in many parts of the world (e.g., the Unites States) it has been observed that more revenue is generated by users/payers who install mobile apps on weekends in comparison with those who install mobile apps on weekdays. Additionally or alternatively, GDP per capita can be correlated with ARPI, hence using GDP per capita can be helpful in generating more appropriate bids in countries with little or no data. Those of ordinary skill in the art can appreciate that the start of a weekend can vary from country to country and from time zone to time zone. It has also been observed that higher ARPIs can be expected to occur on or around certain holidays (e.g., Christmas). These observations can contribute to higher value being placed (e.g., in bids) for published impressions of content and/or content installation during weekend periods and/or certain holiday periods.

Table I provides an exemplary embodiment of a data table, in which x₁, x₂, . . . , and xₙ can each represent a columnar feature, an external feature, or a combination thereof.

TABLE I

| | | | | | | Payer |
|---|---|---|---|---|---|---|
| User | x₁ | x₂ | . . . | xₙ | Revenue | (1/0) |

| | |
|---|---|
| 1 | . . . |
| 2 | . . . |

Because the revenue values of users can vary over time, the data table can include a set of most recent data from the past M days, where M is an integer greater than or equal to unity (e.g., 1, 2, 4, 7, 14, or higher). Those skilled in the art can appreciate that the number, type, and/or character of features in the data table can change with time, especially as channels or publishers add new targeting features that were not previously available. Furthermore, data can be refreshed, for example, daily or at some other suitable period of time.

In a next step, in order to model the data, rows having a binary 1 in the payer column, indicating that the user is a payer (e.g., a user who generated revenue for the application), can be extracted and subjected to a first regression analysis, e.g., using a Random Forest model or similar regression model (STEP 2). The input parameters for the first regression model can include one or more of the targeting features (or parameters) used. In some implementations, revenue can be used as the dependent variable for the regression analysis, and all or some portion of the targeting features (e.g., x₁, x₂, . . . , xₙ) can be used as the independent variables. In general, the regression analysis can be used to generate a first regression model (e.g., a first Random Forest model) for predicting revenue per payer, for a given set of targeting features (e.g., user segments or external features). For example, when the first regression model receives as input a set of targeting features (e.g., 20-30 year old males residing in Germany), the first regression model can provide as output a predicted amount of revenue that each payer corresponding to the targeting features will generate. The amount of revenue can be or include, for example, an average or a median amount of revenue generated per payer (e.g., in the software application).

In some implementations, for example, for CPI analyses, the data in the data table can be used to calculate a payer-to-install value, for example, for each user segment or each user segment of interest (STEP 3A). More particularly, the payer-to-install value can be calculated as a quotient of the total number of payers divided by the total number of installations for each unique set or desired combination of targeting features (x₁, x₂, . . . , xₙ) or independent variables. In SQL, the above can be effected using a GROUP BY function.

Once this has been accomplished, selected data can be subjected to a second regression analysis, e.g., using a Random Forest or other regression model, to generate a second regression model for predicting payer-to-install ratios (STEP 4A). In some implementations, the payer-to-install values calculated from the data can be used as the dependent variable and all or some portion of the targeting features (x₁, x₂, . . . , xₙ) can be used as the independent variables. The number of installations generated by the user segment can be used in the regression analysis model as a weight to provide a weighted average for all installations. In general, the second regression model can receive as input a set of targeting features (e.g., 20-30 year old males residing in Germany) and provide as output a predicted payer-to-install ratio corresponding to the targeting features. The payer-to-install ratio can be or include, for example, a ratio of the number of payers for a software application (e.g., the number of users that generate revenue for the software application) to the total number of users of the software application (e.g., all users who installed the software application, including payers and non-payers). For example, when the payer-to-install ratio for a software application is 0.1, 1 out of every 10 users who install the software application is a payer.

A preliminary or raw CPI bid can then be generated (STEP 5) for a given set of targeting features using the first regression model and the second regression model. For example, in some variations, the preliminary CPI bid can equal the product of the expected or predicted revenue per payer, as determined by the first regression model in STEP 3A, multiplied by the expected or predicted payer-to-install ratio, as determined by the second regression model in STEP 4A. This can be determined from:

$$Preliminary CPI Bid = {( \frac{Revenue}{Payer} )}_{expected} \times {( \frac{Number of Payers}{Installation} )}_{expected} . \qquad ( 2 )$$

With such an approach, the preliminary CPI bid can be equal to a predicted revenue per software installation. When the preliminary CPI bid is $1, for example, the expected revenue, as predicted by the combination of the first and second regression models, is $1 for each installation.

A final CPI bid can be generated (STEP 6) by dividing the preliminary CPI bid from STEP 5 by a current ROI goal or expectation. This can be determined from:

$$Final CPI Bid = \frac{Preliminary CPI Bid}{1 + ROI Goal} . \qquad ( 3 )$$

When the preliminary CPI bid is $1 and the ROI goal is 20%, for example, the final CPI bid is $0.83.

In order to refresh the bids, STEPS 1 through 6 can be repeated, for example, daily or for some comparable period of time (STEP 7). Moreover, in order to ensure that optimal parameters are being used in the models, hyperparameter tuning can be performed, for example, weekly or for some suitable period of time (STEP 8). For example, when using Random Forest modeling which has few tunable parameters, a GRID SEARCH feature can be used to identify parameters that generate the smallest out-of-bag error. For other regression modeling methods, with many parameters, Bayesian or Gradient-based optimization can be used to tune parameters. In general, tuning can involve adjusting the first regression model and/or the second regression model to provide a better fit with data available in the data table. Such tuning can be necessary when new data are collected and/or when changes to the data occur.

Those of ordinary skill in the art can also appreciate that the method and steps described herein in connection with a CPI bid approach can also be used to generate preliminary and final bids for other pricing models, such as a CPE pricing model. For example, for a CPE bid, in lieu of calculating and predicting a payer-to-install ratio for the user segments, as described in STEPS 3A and 4A above, the method 10 can involve using data in the data table to calculate a payer-to-event ratio for the user segments (STEP 3B). A second regression model can then be generated by performing a regression analysis (e.g., using a Random Forest or other regression model) on the calculated payer-to-event ratio values (STEP 4B). Once generated, the second regression model in this case can be used to predict the payer-to-event ratio for a given set of targeting features (x₁, x₂, . . . , xₙ). A preliminary CPE bid can be calculated (STEP 5) from the outputs of the first and second regression models, for example, as follows:

$$Preliminary CPE Bid = {( \frac{Revenue}{Payer} )}_{expected} \times {( \frac{Number of Payers}{Event} )}_{expected} . \qquad ( 4 )$$

Likewise, a final CPE bid can be determined (STEP 6) from an ROI goal, for example, using

$$Final CPE Bid = \frac{Preliminary CPE Bid}{1 + ROI Goal} . \qquad ( 5 )$$

The event associated with the CPE bid can be an event associated with certain user activity or user events. The user event can be, for example, a user accomplishment in the software application. In one example, the user event can be a level of advancement or accomplishment in a software application for a computer game, such as a multiplayer online game.

In various examples, the systems and methods described herein can use two regression analyses or models to calculate bids for various pricing models, including CPI and CPE. A first regression analysis or model can be used to predict revenue per payers and a second regression analysis or model can be used to predict, for example, a payer-to-install ratio (for CPI pricing) or a payer-to-event ratio (for CPE pricing). In other examples, the second regression analysis or model can be used to predict different ratios (e.g., payer-to-click), for other pricing models (e.g., CPC pricing). A product of the model outputs can then be used to predict a revenue per installation, as shown in equations (2) and (4). While it is possible, in some instances, to develop and use a single regression model to predict revenue per installation (or revenue per event) directly, the use of two regression models (e.g., the first and second regression models) to predict revenue per installation indirectly, as in the method 10, is generally preferred. For example, compared to a direct approach that uses a single regression model, the use of two regression models has been found to yield more stable results and to be less susceptible to generating skewed predictions, for example, due to the presence of a whale. In general, by predicting revenue generated by payers of user segments, in STEP 2, while weighing each payer equally, the two-step approach is less likely to result in an extremely high prediction (e.g., of revenue per installation), unless a user segment includes multiple whales, which is unlikely. When predicting revenue per payer, each training data point corresponds to a single payer; hence, equal weight can be attributed to each data point. In contrast, as previously described, when predicting a number of payers per installation, training data points can be generated by a different number of installations, e.g., a first training data point can be generated by 100 installations, while a second training data point can be generated by five installations; hence, a weighted average can be used to account for a statistical bias in the number of installations. For the example described, weight averaging can include multiplying the first training data point by 100/(100+5) and multiplying the second training data point by 5/(100+5).

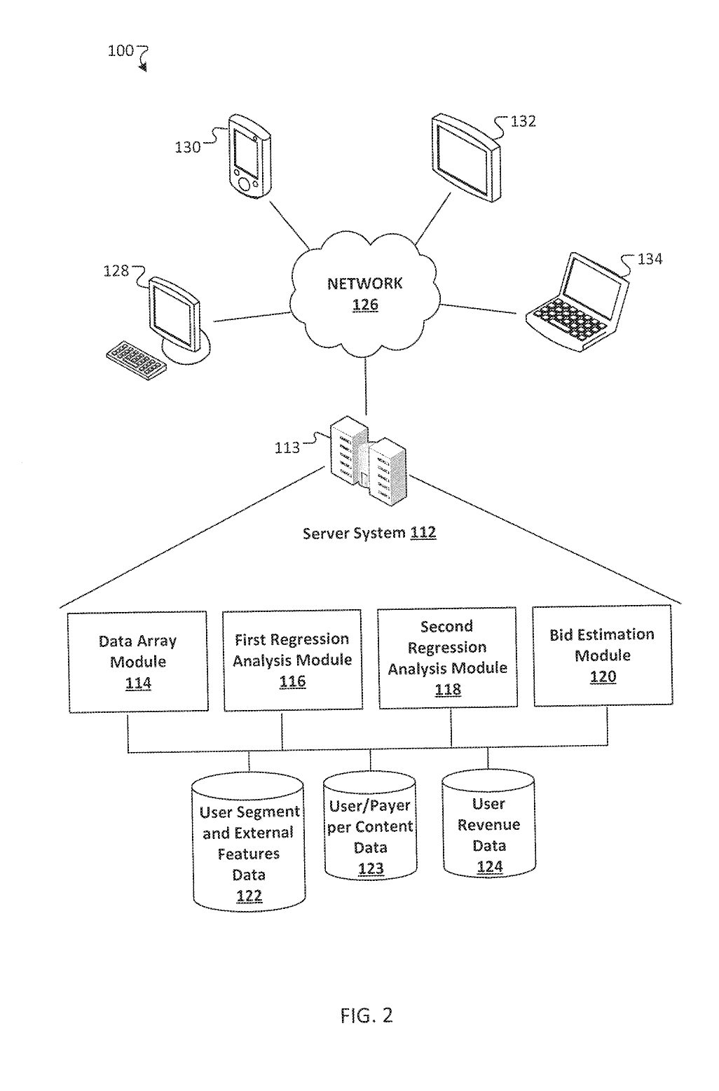

FIG. 2 illustrates an exemplary system 100 for developing and using regression models to predict bids for content presentations. A server system 112 provides functionality for processing data, developing regression models, and calculating bids using the models. The server system 112 includes software components and databases that can be deployed at one or more data centers 113 in one or more geographic locations, for example. In certain instances, the server system 112 is, includes, or utilizes a content delivery network (CDN). The server system 112 software components can include a data array module 114, a first regression analysis module 116, a second regression analysis module 118, and a bid estimation module 120. The software components can include subcomponents that can execute on the same or on different individual data processing apparatus. The server system 112 databases can include a user segment and external features data 122 database, a user/payer per content data 123 database, and a user revenue data 124 database. The databases can reside in one or more physical storage systems. The software components and data will be further described below.

In some implementations, the system 100 can include a web-based application that can be provided as an end-user application to allow multiple users to interact with a server system 112. The application can be accessed through a network 126 (e.g., the Internet, a LAN, a WAN, and the like) by users via a myriad of client devices, e.g., a personal computer 128, a smart phone 130, a tablet computer 132, a laptop computer 134, and so forth. Other client devices are possible. In alternative examples, the user segment and external features data 122 database, the user/payer per content data 123 database, the user revenue data 124 database, or any portions thereof can be stored on one or more client devices. Additionally or alternatively, software components for the system 100 (e.g., the data array module 114, the first regression analysis module 116, the second regression analysis module 118, and the bid estimation module 120) or any portions thereof can reside on or be used to perform operations on one or more client devices.

In some variations, as shown in FIG. 2, the data array module 114, the first regression analysis module 116, the second regression analysis module 118, and the bid estimation module 120 can communicate with the user segment and external feature data 122 database, the user/payer data 123 database, and the user revenue data 124 database. In general, the user segment and external feature data 122 database, the user/payer data 123 database, and/or the user revenue data 124 database can include or store data for the data table described herein (e.g., in Table I). Such data can be used to generate predictive models (e.g., the first and second regression models), which can be used to calculate bids for content presentations.

For example, the user segment and external feature data 122 database generally includes information related to user segments, external features, or other targeting features, for launched or presented content (e.g., images or videos) implemented using the system 100. The user segment and external feature data 122 database can include, for example, user segment information for users (e.g., age, gender, etc.), information related to user devices and user geographical locations, and similar information.

The user/payer per content data 123 database generally includes data related to users who installed and/or used software applications (e.g., mobile apps), for example, in response to content presented on the client devices. Such information can be or include, for example, a record of user interactions and/or accomplishments with the software applications.

The user revenue data 124 database generally includes information related to payers or users who installed software applications and generated revenue in or using the software applications. Such information can be or include, for example, a record of any payments or purchases made by users in or using the software applications and/or a record of any other revenue generated by users of the software application.

In one implementation, the data array module 114 can be adapted to store, arrange, or manipulate data in a data table. The data can be arranged in columns and rows, as described herein, for example, with respect to Table I.

In some applications, the first regression analysis module 116 can be used to perform a regression analysis on the data in the data table to generate the first regression model, as described herein. Additionally or alternatively, the second regression analysis module 118 can be used to perform a regression analysis on the data in the data table to generate the second regression model, as described herein. In general, the bid estimation module 120 can be used to calculate bids using the first regression model and the second regression model, described herein. For example, the bid estimation module 120 can calculate a preliminary bid by combining the outputs from the first and second regression models, as shown in equations (2) and (4).

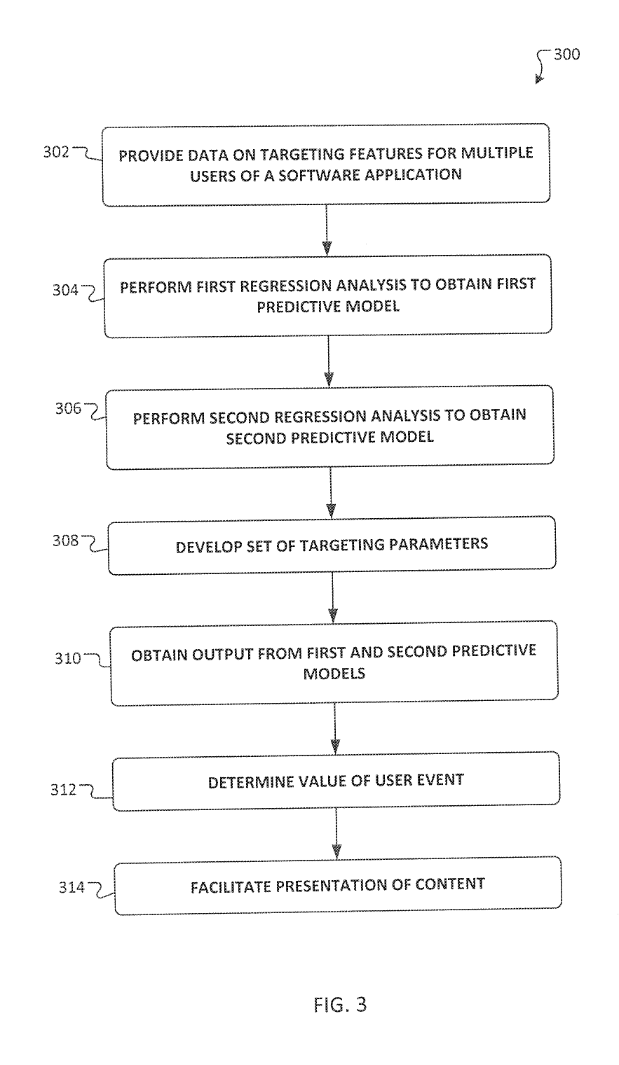

FIG. 3 illustrates an exemplary computer-implemented method 300 of developing and using predictive models to determine a value of user events. Initially, data on a plurality of targeting features (e.g., one or more user segments, one or more external features, and so forth) for a plurality of users of a software application can be provided (STEP 302). In some implementations, these data include user interactions with the software application. Using one or more of the targeting features contained in these data, a first regression analysis can be performed to generate a first predictive model (STEP 304). In some variations, the input for the first predictive model can include one or more targeting features, while the output can provide a prediction of an amount of revenue generated per payer for the software application. Again, using one or more of the targeting features contained in these data, a second regression analysis can be performed to generate a second predictive model (STEP 306). In some variations, the input for the second predictive model can include one or more targeting features, while the output can provide a prediction of a number of payers per user event (e.g., a software installation) for the software application.

Having performed first and second regression analyses and generated first and second predictive models, a set of targeting parameters can be developed for use in the first and second predictive models (STEP 308). With the set of targeting parameters as input, output from each of the first and second predictive models can be obtained (STEP 310). More particularly, output from the first predictive model can include an amount of revenue generated by each payer for the software application, while output from the second predictive model can include a number of payers per user event, which can include or be based on CPE and/or CPI pricing models. Based on a combination of these two outputs, a value of the user event can be determined (STEP 312), which can be used to facilitate a presentation of content on one or more client devices (STEP 314).

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A computer-implemented method for determining a value of a user event, the method comprising:
providing data comprising a plurality of targeting features for a plurality of users of a software application;
identifying a plurality of payers within the plurality of users;
performing a first regression analysis on the data to generate a first predictive model, the first predictive model being configured to receive at least one targeting feature as input and provide as output a prediction of an amount of revenue generated per payer for the software application;
performing a second regression analysis on the data to generate a second predictive model, the second predictive model being configured to receive at least one targeting feature as input and provide as output a prediction of a number of payers per user event for the software application;
providing a set of targeting parameters to the first predictive model and the second predictive model;
receiving outputs from the first predictive model and the second predictive model;
determining a value of the user event based on a combination of the outputs; and
facilitating a presentation of content on a plurality of client devices based on the determined value.

2. The method of claim 1, wherein the data comprises a history of user interactions with the software application.

3. The method of claim 1, wherein the targeting features comprise at least one of a user segment and an external feature.

4. The method of claim 1, wherein performing the first regression analysis comprises calculating, based on the data, an amount of revenue generated by each payer for the software application.

5. The method of claim 1, wherein performing the second regression analysis comprises calculating, based on the data, a number of payers per user event.

6. The method of claim 1, wherein at least one of the first predictive model and the second predictive model comprises a Random Forest model.

7. The method of claim 1, wherein the user event comprises at least one of an installation of the software application and a user accomplishment in the software application.

8. The method of claim 1, wherein the number of payers per user event comprises a payer-to-install ratio.

9. The method of claim 1, wherein providing the set of targeting parameters comprises determining the set of targeting parameters for a group of prospective users of the software application.

10. The method of claim 1, wherein determining the value of the user event comprises multiplying output from the first predictive model by output from the second predictive model.

11. A system, comprising:
one or more computer processors programmed to perform operations comprising:
providing data comprising a plurality of targeting features for a plurality of users of a software application;
identifying a plurality of payers within the plurality of users;
performing a first regression analysis on the data to generate a first predictive model, the first predictive model being configured to receive at least one targeting feature as input and provide as output a prediction of an amount of revenue generated per payer for the software application;
performing a second regression analysis on the data to generate a second predictive model, the second predictive model being configured to receive at least one targeting feature as input and provide as output a prediction of a number of payers per user event for the software application;
providing a set of targeting parameters to the first predictive model and the second predictive model;
receiving outputs from the first predictive model and the second predictive model;
determining a value of the user event based on a combination of the outputs; and
facilitating a presentation of content on a plurality of client devices based on the determined value.

12. The system of claim 11, wherein the targeting features comprise at least one of a user segment and an external feature.

13. The system of claim 11, wherein performing the first regression analysis comprises calculating, based on the data, an amount of revenue generated by each payer for the software application.

14. The system of claim 11, wherein performing the second regression analysis comprises calculating, based on the data, a number of payers per user event.

15. The system of claim 11, wherein at least one of the first predictive model and the second predictive model comprises a Random Forest model.

16. The system of claim 11, wherein the user event comprises at least one of an installation of the software application and a user accomplishment in the software application.

17. The system of claim 11, wherein the number of payers per user event comprises a payer-to-install ratio.

18. The system of claim 11, wherein providing the set of targeting parameters comprises determining the set of targeting parameters for a group of prospective users of the software application.

19. The system of claim 11, wherein determining the value of the user event comprises multiplying output from the first predictive model by output from the second predictive model.

20. An article, comprising:
a non-transitory computer-readable medium having instructions stored thereon that, when executed by one or more computer processors, cause the computer processors to perform operations comprising:
providing data comprising a plurality of targeting features for a plurality of users of a software application;
identifying a plurality of payers within the plurality of users;
performing a first regression analysis on the data to generate a first predictive model, the first predictive model being configured to receive at least one targeting feature as input and provide as output a prediction of an amount of revenue generated per payer for the software application;
performing a second regression analysis on the data to generate a second predictive model, the second predictive model being configured to receive at least one targeting feature as input and provide as output a prediction of a number of payers per user event for the software application;
providing a set of targeting parameters to the first predictive model and the second predictive model;
receiving outputs from the first predictive model and the second predictive model;
determining a value of the user event based on a combination of the outputs; and
facilitating a presentation of content on a plurality of client devices based on the determined valu
